(19) United States
(12) Patent Application Publication
(10) Pub. No.: US 2024/0125975 A1
(43) Pub. Date: Apr. 18, 2024

(54) SYSTEMS AND TECHNIQUES FOR FORMING META-LENSES

(71) Applicant: QUALCOMM Incorporated, San Diego, CA (US)

(72) Inventors: Matthieu Jean Olivier DUPRE, La Jolla, CA (US); Biay-Cheng HSEIH, Irvine, CA (US); Jian MA, San Diego, CA (US); Sergiu Radu GOMA, Sedona, AZ (US)

(21) Appl. No.: 18/483,273

(22) Filed: Oct. 9, 2023

Related U.S. Application Data
(60) Provisional application No. 63/379,622, filed on Oct. 14, 2022.

(51) Int. Cl. G02B 1/00; G02B 3/00; G02B 27/00

(52) U.S. Cl. CPC G02B 1/002; G02B 3/0012; G02B 27/0012

(57) ABSTRACT

Systems and techniques are provided for imaging with a meta-lens. For instance, a process can include receiving light at a first substrate, the first substrate comprising a first meta-lens; receiving a first portion of the light at a second substrate, the second substrate including an optical sensor, wherein: the optical sensor is directly covered by a solid covering, and the first substrate is mechanically coupled to the second substrate such that the solid covering is between the first substrate and the second substrate; and receiving, by the optical sensor and through the solid covering, at least a second portion of the light focused by the first meta-lens.

### CROSS-REFERENCE TO RELATED APPLICATIONS

This application claims the benefit of U.S. Provisional Application No. 63/379,622, filed Oct. 14, 2022, which is hereby incorporated by reference, in their entirety and for all purposes.

### FIELD

The present disclosure generally relates to optical systems utilizing meta-lenses. In some examples, aspects of the present disclosure are related to systems and techniques related to meta-lens assemblies.

### BACKGROUND

Many devices and systems include optical elements, such as lenses for focusing light onto an image sensor. For example, a camera or a device including a camera with such optical elements can capture a frame or a sequence of frames of a scene (e.g., a video of a scene). In order to achieve desirable optical characteristics (e.g., including but not limited to sharpness, wide field of view, among others), the camera or camera device can utilize refractive lenses to focus incoming light onto an optical sensor. In some cases, a lens for a camera device can be a compound lens that includes multiple refractive lens elements stacked together. In some cases, the overall thickness of the compound lens stack can add additional size to a device that includes the compound lens stack.

Meta-lenses can provide an alternative to refractive lenses. Meta-lenses can be formed by fabricating nanometer scale (also referred to herein as nanoscale) geometric structures on a substrate material. The nanoscale geometric structures can control the transmission, polarization, and phase of light passing through the nanoscale geometric structures based on physical characteristics (e.g., height, width, length, diameter, etc.) of the nanoscale geometric structures. In some cases, meta-lenses can be fabricated using a fabrication technique, such as electron beam (e-beam) lithography.

### SUMMARY

Systems and techniques are described herein for forming meta-lens cameras. The systems and techniques provide solutions for visible applications, infrared (e.g., near-infrared (NIR)) applications, and/or other applications. For example, an apparatus is provided. The apparatus includes: a first substrate comprising a first meta-lens; and a second substrate, the second substrate including an optical sensor, wherein: the optical sensor is directly covered by a solid covering, and the first substrate is mechanically coupled to the second substrate such that the solid covering is between the first substrate and the second substrate.

As another example, a method for imaging is provided. The method includes: receiving light at a first substrate, the first substrate comprising a first meta-lens; receiving a first portion of the light at a second substrate, the second substrate including an optical sensor, wherein: the optical sensor is directly covered by a solid covering, and the first substrate is mechanically coupled to the second substrate such that the solid covering is between the first substrate and the second substrate; and receiving, by the optical sensor and through the solid covering, at least a second portion of the light focused by the first meta-lens.

In another example, an apparatus is provided. The apparatus includes: means for receiving light at a first substrate, the first substrate comprising a first meta-lens; means for receiving a first portion of the light at a second substrate, the second substrate including an optical sensor, wherein: the optical sensor is directly covered by a solid covering, and the first substrate is mechanically coupled to the second substrate such that the solid covering is between the first substrate and the second substrate; and means for receiving, by the optical sensor and through the solid covering, at least a second portion of the light focused by the first meta-lens.

In some aspects, one or more of the apparatuses described herein is, is part of, or includes a camera or multiple cameras, a mobile device (e.g., a mobile telephone or so-called “smart phone” or other mobile device), a wearable device (e.g., a smartwatch, a fitness tracking device, etc.), an extended reality device (e.g., a virtual reality (VR) device, an augmented reality (AR) device, or a mixed reality (MR) device), a personal computer, a laptop computer, a server computer, a vehicle (e.g., a computing device of a vehicle), or other device. In some aspects, the apparatus further includes one or more displays for displaying one or more images, notifications, and/or other displayable data. In some aspects, the apparatus can include one or more sensors, which can be used for determining a location and/or pose of the apparatus, a state of the apparatus, and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

Illustrative embodiments of the present application are described in detail below with reference to the following figures:

FIG. 1A is a perspective view of an example meta-lens, in accordance with some examples;

FIG. 1B is a lateral view of an example meta-lens, in accordance with some examples;

FIG. 2 is a diagram illustrating example magnified portions of a meta-lens, in accordance with some examples;

FIG. 3 are diagrams illustrating lateral views of a compound lens and a corresponding meta-lens, in accordance with some examples;

FIG. 4A through FIG. 4F are diagrams illustrating a meta-lens wafer stackup fabrication technique, in accordance with some examples;

FIG. 5A through FIG. 5D are diagrams illustrating an example nanoimprinting technique for fabricating meta-lenses, in accordance with some examples;

FIG. 6 is a diagram illustrating an example meta-lens wafer stackup, in accordance with some examples;

FIG. 7A through FIG. 7C are diagrams illustrating an example meta-lens wafer stackup, in accordance with some examples;

FIG. 8A through FIG. 8E are diagrams illustrating cross-sections of example meta-lens stackup configurations, in accordance with some examples;

FIG. 9A and FIG. 9B are diagrams illustrating cross-sections of example meta-lens arrays on stacking imager wafers, in accordance with some examples;

FIG. 10A through FIG. 10E are diagrams illustrating cross-sections of example meta-lens camera cube configurations, in accordance with some examples;

FIG. 11 is a diagram illustrating an example of a computing system for implementing certain aspects described herein; and

FIG. 12 is a flow diagram illustrating an example of a process for imaging, in accordance with some examples.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

Many devices and systems include optical elements, which can include lenses for focusing light onto an image sensor. In one example, a camera or a device including a camera (e.g., a mobile device, an extended reality (XR) device, etc.) with optical elements can capture a frame or a sequence of frames of a scene (e.g., a video of a scene). In order to achieve desirable optical characteristics (e.g., sharpness, wide field of view, etc.), the camera or camera device can utilize refractive lenses to focus incoming light on an image sensor. In some cases, a lens for a camera device can include compound lens comprising multiple refractive lens elements stacked together. In some cases, the overall thickness of the compound lens stack can add additional size to a device that includes the camera lens stack as part of a camera system.

In contrast to a refractive lens, a meta-lens is a lens made with meta-surface technology. A meta-surface is a flat optical component designed at the nanometer (nm) scale with small geometrical features on the surface. In some cases, the small geometrical features can control the transmission, polarization, and phase of light passing through the meta-lens. In one illustrative example, the small geometric features making up a meta-lens can include pillars or columns (sometimes referred to as nanopillars). In some cases, the effect on light passing through the pillars can depend on the geometry of the pillars such as the height of the pillars, diameter of the pillars, and pitch of the pillars. In some implementations, the pillars can have a constant height and the effect on light passing through the pillars can be varied by providing pillars with different diameters.

In some cases, meta-lenses can be fabricated in a piece-by-piece fashion using an electron beam (e-beam) lithography technique. In the e-beam lithography technique for fabricating meta-lenses, a focused e-beam can be scanned across a surface of a substrate to create a pattern corresponding to the desired meta-surface structure. In some cases, the surface of the substrate can be coated in a resist material that changes characteristics when exposed to e-beam energy. Depending on the type of resist material used, either the exposed resist material or the non-exposed resist material can be selectively removed while the other portion remains on the surface of the substrate. Where the resist material is selectively removed, the substrate can be exposed and can be etched (e.g., by wet etching, dry etching, reactive-ion etching (RIE), or the like) to remove a portion of the substrate material. In some cases, the etching process can create geometric features of the meta-surface on the surface of the substrate material to form a meta-lens. In some cases, because the geometric features of the meta-surface have to be patterned onto the resist material by directing a focused e-beam at the resist material, the process of fabricating can be time consuming and costly.

Systems, apparatuses, processes (also referred to as methods), and computer-readable media (collectively referred to as “systems and techniques”) are described herein for manufacturing meta-lenses and optical systems including meta-lenses in a scalable manner. For example, semiconductor manufacturing technology is used to produce multiple devices (e.g., microprocessors, application specific integrated circuits, or the like) simultaneously on a single silicon wafer. In contrast to the e-beam lithography technique described above, features fabricated on the surface of the silicon wafer are not individually drawn. Instead, the features (or a negative representation of the features) of a device can be patterned on to a mask. The features of a single device can be repeated in array to fill the area (or a portion of the area) of a surface of a silicon wafer with multiple devices. With a single exposure of light, the pattern on the mask can be transferred to a photosensitive resist (photoresist) material. In the case of semiconductor manufacturing, multiple masks may be used to fabricate different features of a device such as metal layers, transistors, passivation layers, mechanical structures or the like. Accordingly, it would be advantageous if the photolithography process used for manufacturing semiconductors could also be used to manufacture meta-lenses.

In some cases, a wafer level fabrication of meta-lenses (e.g., meta-lens cameras) can include using metasurfaces (ultrathin flat elements replacing conventional lenses) made of silicon to be very cost-effectively integrated into depth sensors. At short-wave infrared (SWIR) wavelengths (e.g., 1100-2500 nm), silicon is transparent for light and high index. Furthermore, meta-lenses can be efficiently designed for narrowband light (e.g., one wavelength), which can be the use case of depth-sensors that use laser for illumination. Hence, SWIR depth sensors are a good use case of meta-lenses. Using a silicon meta-lens, on top of a bridge/air gap spacer on top of a sensor (e.g., GeSi or InGaAs), on top of a digital image processing unit may allow the fabrication of low-cost monolithic silicon depth sensor units.

The systems and techniques can build upon such a wafer level fabrication of meta-lenses to realize more complex optical systems in an even more compact and more cost-effective way. For instance, the air gap can be removed and replaced by the silicon of a sensor (e.g., a Back Side Illuminated sensor (BSI)), or in some cases a simple Bulk silicon Wafer.

Replacing the air gap by silicon spacers can have several advantages. As noted above, silicon is transparent at SWIR wavelengths (e.g., more than 1100 nm), so it would not impact any optical properties of the sensor. At fabrication, the process would include stacking two or more flat surfaces, which can be done easily during the fabrication process. Silicon has a high refractive index (e.g., approximately 3.4), which means that the thickness of the spacer can be reduced by a 3.4 (or other value associated with the refractive index) with respect to an air gap spacer (e.g., 1 millimeter (mm) instead of 3.4 mm distance between the lens and the active sensor area), leading to a more compact sensor. Furthermore, it can be easier to stack flat surfaces on top of flat surfaces, and does not require alignment nor the design and fabrication of a specific air gap spacer wafer, driving the complexity and cost down. Several meta-lenses can be stacked and alternated on top on flat silicon spacers as needed to design more complex optical systems. Some lens systems comprise several lenses (e.g., 5-10 lenses), and the systems and techniques described herein can allow the optical performances of a meta-lens sensor to be significantly increased when needed. Moreover, the systems and techniques provide versatility, where the order of elements can be changed if appropriate, such as putting an optical filter before or after.

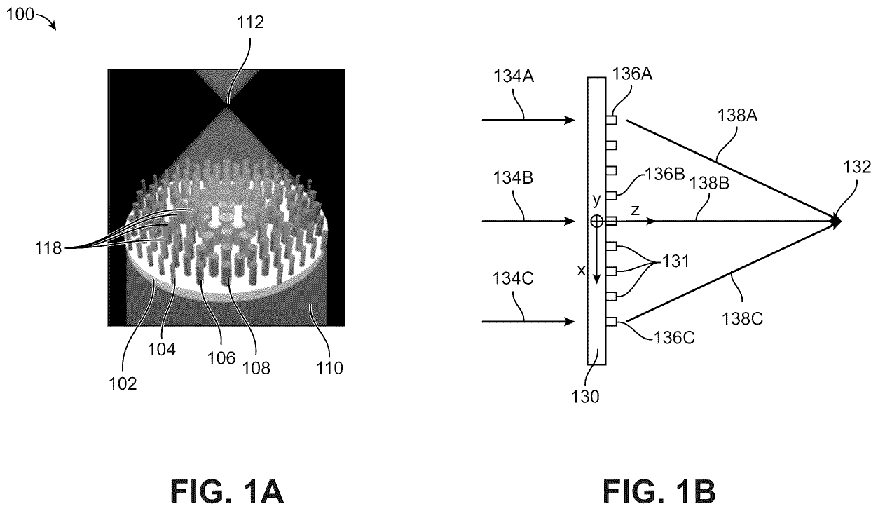

Various aspects of the techniques described herein will be discussed below with respect to the figures. FIG. 1A and FIG. 1B illustrate views of an example meta-lens. In the illustrated example of FIG. 1A, a meta-lens 100 includes a substrate 102 (also referred to as a base) having multiple pillars 118 including pillars 104, 106, 108 disposed on the surface of the substrate 102. In some cases, the pillars 118 can be an example of nanoscale geometric structures forming a meta-surface. The pillars 104, 106, 108 can be nanostructures having a height on the nanometer scale. In some implementations, the height of the nanostructures (e.g., pillars 118) can be on the order of the wavelength of light relevant to a particular application. In one illustrative example, a pillar height between 1100 nanometer (nm) and 1200 nm can be used for a meta-lens in a SWIR application (e.g., for wavelengths between 1380 nm and 1550 nm). In another illustrative example, a pillar height between 300 nm and 400 nm can be used for a meta-lens in a visible light application (e.g., for wavelengths between 350 nm and 800 nm) In some implementations, the pillars 104, 106, and 108 can have a common height H. In the illustrated example of FIG. 1A, the pillars 104, 106, 108 can have different diameters, where the pillar 104 is shown with the smallest diameter, the pillar 106 is shown with a diameter larger than the pillar 104, and the pillar 108 is shown with a diameter larger than pillar 104 and pillar 106. In the illustration of FIG. 1A, additional pillars of different sizes disposed on the substrate 102 are also shown. FIG. 1A illustrates a column of light 110 incident upon the meta-lens 100. As will be explained in more detail below, the pillars of the meta-lens 100, including pillars 104, 106, 108 can shift the phase of the rays of the column of light 110 so that the rays of the incident column of light 110 converge to a focal point 112 with a common phase. In some cases, the column of light is collimated. In some cases, the distance between the meta-lens 100 and the focal point 112 can be referred to as the focal distance of the meta-lens 100. While the examples of this disclosure include example meta-lenses utilizing pillars 118 as the geometric features forming a meta-surface that forms the meta-lens, the systems and techniques described herein can be used with meta-lenses that include features other than pillars without departing from the scope of the present disclosure.

FIG. 1B illustrates a lateral view of an example meta-lens 130 that can be configured to focus light at a focal point 132. In some cases, the meta-lens 130 can include a plurality of pillars 131 (which can correspond to pillars 118 shown in FIG. 1A) on one surface of the meta-lens 130. The pillars 118 illustrated in FIG. 1B are shown for illustration are not shown to scale. In addition, the number, height, diameter, and/or pitch of the pillars 118 shown in FIG. 1B are only provided as an example. Other meta-lens configurations can be used without departing from the scope of the present disclosure. For example, each individual pillar of the pillars 118 shown in FIG. 1B could represent a group of pillars in a meta-lens. In the illustrated example of FIG. 1B, the pillars 136A, 136B, 136C can provide different phase delays to incoming light. For example, light passing through pillar 136B will experience a larger phase delay than pillar 136A or pillar 136C. In some cases, the pillars 136A, 136B, 136C can represent groups of pillars that provide different phases delays to incoming light. In the illustrated example of FIG. 1B, light rays 134A, 134B, 134C can be incident upon the meta-lens 130. In the illustrated example of FIG. 1B, light ray 134A passes through a first pillar 136A, light ray 134B passes through a second pillar 136B, and light ray 134C passes through a third pillar 136C. The light rays 138A, 138B, 138C represent the path of light rays 134A, 134B, 134C after passing through the respective pillars 136A, 136B, 136C. As illustrated in FIG. 1B, the rays 138A and 138C travel from edges of the meta-lens 130 and can travel a greater distance than the ray 138B to reach the focal point 132. In some implementations, each of the pillars 136A, 136B, 136C can be configured with a phase shift such that each of the rays 138A, 138B, 138C arrive at the focal point 132 with an identical phase. The phase shift experienced by light rays (e.g., 134A, 134B, 134C) passing through the pillars 136A, 136B, 136C can be controlled as a function of the geometry of the pillars 136A, 136B, 136C. In some cases, an amount of phase shift experienced by light passing through the pillar 118 can depend on the height H, the diameter D, the wavelength of the light, the angle of incidence, and the polarization of the light passing through the pillar.

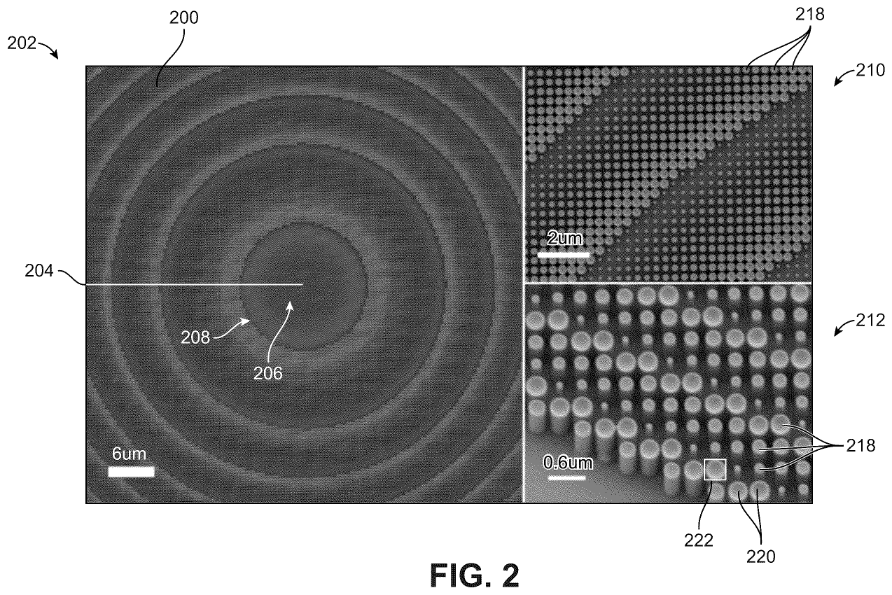

FIG. 2 illustrates example magnified portions of a meta-lens 200 illustrating a pattern of unit cells with varying pillar diameters. As illustrated in FIG. 2, a low magnification level view 202 of the meta-lens 200 shows that the pattern of pillars 218 (which can correspond to pillars 118 shown in FIG. 1A above) of the meta-lens 200 can have a radially symmetric pattern extending from the center of the meta-lens 200 to the periphery of the meta-lens 200. In the illustration of FIG. 2, a line segment 204 extending radially from the center 206 of the meta-lens 200 is drawn. Near the center 206 of the meta-lens 200, the diameter of the pillars 218 can have a maximum value. In one illustrative example, the diameter of the pillars 218 at the center of the meta-lens 200 can be approximately equal to or slightly smaller than the width U of a unit cell. Moving away from the center 206 of the meta-lens 200, the pillar size can decrease (providing a correspondingly smaller phase shift) relative to the pillars at the center 206 of the meta-lens until a phase reset point 208 is reached. At the phase reset point 208, the size of the pillars 218 can be reset to the largest diameter. In some cases, the varying diameters of the pillars 218 can create a ring-like appearance. The medium magnification level 210 and high magnification level 212 further illustrate the appearance of the pillars within the unit cells. As illustrated, the pillars 218 can be centered on a common pitch and large pillars 220 can have a diameter slightly smaller than the width U of a unit cell 222 (depicted as a white square).

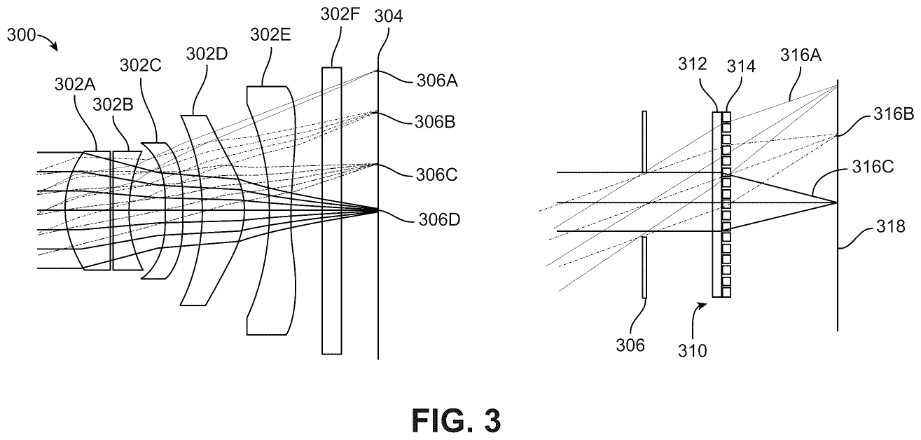

FIG. 3 illustrates lateral views of a compound lens 300 and a corresponding meta-lens 310 that can have similar optical characteristics. In the illustration of FIG. 3, the compound lens 300 includes lens elements 302A, 302B, 302C, 302D, 302E, and a sensor cover glass 302F that when stacked together can provide desired optical characteristics for a particular application. For example, the compound lens 300 can be designed with a particular target focal range, a wide angle field of view, and desired upper limit amounts of spherical aberration and chromatic aberration, among other characteristics. In the compound lens 300, the various optical elements 302A, 302B, 302C, 302D, 302E, 302F can each refract incoming light rays 306A, 306B, 306C, 306D in different ways such that the overall effect of the optical elements 302A, 302B, 302C, 302D, 302E, 302F, when stacked together, provides the desired optical performance. In the illustrated example, the compound lens 300 can operate to focus the incoming light rays 306A, 306B, 306D, 306D at the focal plane 304. In some examples, an optical sensor (also referred to as an image sensor, image detector, or light sensitive device herein) can be positioned at the focal plane 304 to detect the incoming light. Because multiple elements can be required to achieve the desired characteristics of the compound lens 300, the compound lens can add significant height, weight, and/or cost to a device using the compound lens 300 (e.g., a mobile device). In some cases, a device may have more than one camera as well as other optical sensors, each of which may require multiple separate compound lenses.

In some cases, a meta-lens 310 can be configured to perform with similar optical characteristics to the compound lens 300. In some implementations, a single layer meta-lens 310 can provide the desired optical characteristics for an imaging system (e.g., a camera, a range imager, or the like). In such cases, the meta-lens 310 can provide substantial savings in weight and thickness relative to the compound lens 300. The meta-lens 310 can include a substrate 312 and pillars 314 (e.g., pillars 118 shown in FIG. 1A). In some cases, light rays 316A, 316B, and 316C can arrive at the meta-lens 310 from different angles after passing through an aperture 306. As illustrated in FIG. 3, the meta-lens 310 can focus the light at a focal plane 318. In some examples, an optical sensor can be positioned at the focal plane 318 to detect the incoming light. In some cases, meta-lens 310 structures can be fabricated with an electron beam (e-beam) lithography prospects. In some aspects, e-beam lithography can be a costly and time consuming process because e-beam lithography individually draws the desired structure for each meta-lens. Accordingly, the fabricating meta-lenses in large quantities using e-beam lithography can become prohibitively expensive and time consuming.

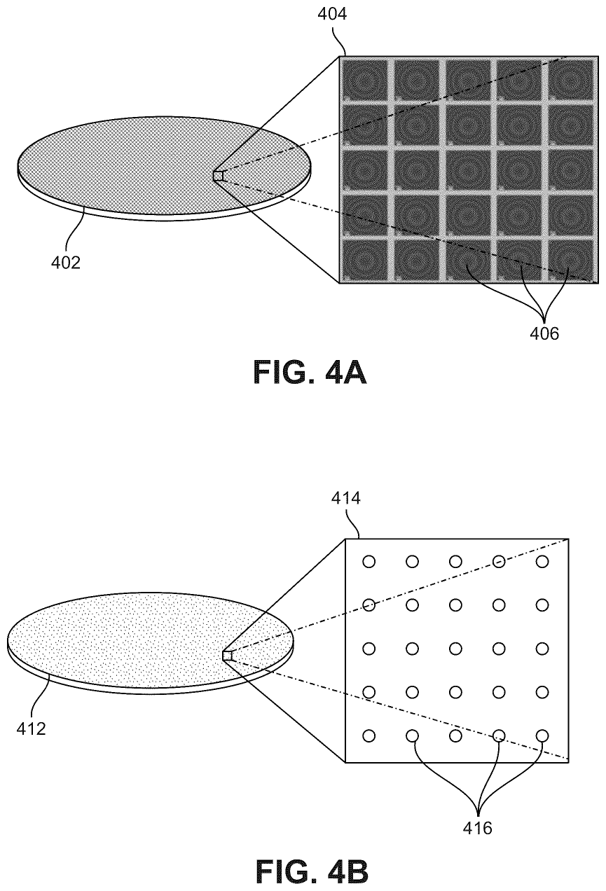

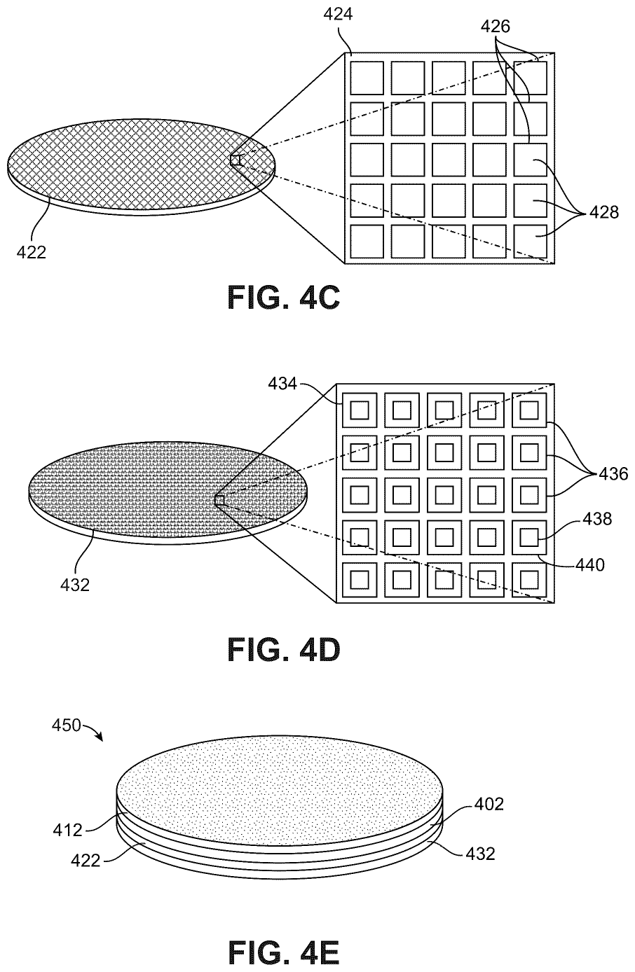

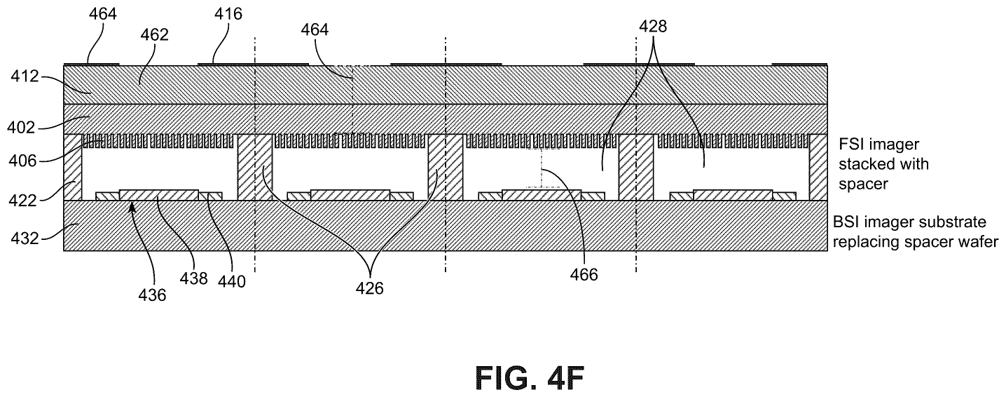

FIG. 4A through FIG. 4E illustrate an example process for manufacturing and assembling a wafer stackup 450 using a wafer stacking technique. FIG. 4A illustrates a perspective view of a meta-lens wafer 402 with a magnified portion 404 depicting an array of meta-lenses 406 fabricated on the meta-lens wafer 402. In some cases, each of the meta-lenses 406 can correspond to any one of the meta-lens 130 shown in FIG. 1B, compound meta-lens 300 shown in FIG. 3, meta-lens 310 shown in FIG. 3, or any other meta-lens. In some cases, the meta-lens wafer 402 can include a silicon wafer. For example, the meta-lens wafer 402 can include a double-side polished silicon wafer. In some cases, the meta-lenses 406 can be fabricated on a silicon wafer using semiconductor manufacturing techniques such as photolithography, reactive ion etching (RIE) and the like. In some cases, the meta-lens wafer 402 can include a material that is transparent to the visible light spectrum (e.g., glass). In some cases, pillars (e.g., pillars 118 shown in FIG. 1A) of the meta-lenses 406 can be fabricated using materials that are transparent to the visible light spectrum. In one illustrative example, a high refractive index material such as Titanium Dioxide (TiO2) can be used to form the pillars.

FIG. 4B illustrates a perspective view of an aperture wafer 412 with a magnified portion 414 depicting multiple apertures 416 fabricated on the meta-lens wafer. In some cases, the aperture wafer can include a silicon wafer. In some cases, the aperture wafer 412 can include a material that is transparent to the visible light spectrum (e.g., glass). In some cases, the multiple apertures 416 can be fabricated by depositing an opaque material on the surface of the aperture wafer 412. In some cases, the opaque material can include any material that is opaque at the wavelength (or range of wavelengths) for a particular optical detection application. Example optical detection applications can include visible light applications (e.g., 350-750 nm), near infra-red (NIR) applications (e.g., 750-1000 nm), SWIR applications (e.g., 1000-2500 nm), or the like.

FIG. 4C illustrates a perspective view of spacer wafer 422 with a magnified portion 424 depicting a pattern of spacer structures 426 fabricated on the spacer wafer 422. In some cases, the spacer wafer 422 can include a silicon wafer. In some cases, the spacer wafer 422 can include a material that is transparent to the visible light spectrum (e.g., glass). In some case the spacer wafer can be made of material that is transparent to SWIR light (e.g. silicon). In some cases, the spacer structures 426 can be fabricated from a dielectric material (e.g., polyimide). In some cases, each of the spacer structures 426 can have dimensions and pitch equal to the dimensions and pitch of the meta-lenses 406 shown in FIG. 4A. In some cases, the spacer structures 426 can include spacer material in a border region that corresponds to the outside border of the meta-lenses 406. In some cases, each spacer structure 426 can form a border around a corresponding meta-lens 406 on the meta-lens wafer 402. In some cases, each spacer structure 426 can form a border around a corresponding optical sensor 436 of the optical sensor wafer 432.

FIG. 4D illustrates a perspective view of an optical sensor wafer 432 with a magnified portion 434 depicting optical sensors 436 disposed on the optical sensor wafer 432. In some cases, the optical sensor wafer 432 can include a silicon wafer. In some cases, the optical sensors 436 can be fabricated with a GeSi CMOS process on the silicon wafer. In some cases, the optical sensors 436 can include a photosensitive region 438. In some cases, the optical sensors 436 can include additional circuitry 440. In some cases, the additional circuitry 440 can include readout circuitry that can be used to read the signals captured by the optical sensors.

FIG. 4E illustrates a wafer stackup 450 comprising the aperture wafer 412, the meta-lens wafer 402, the spacer wafer 422 and the optical sensor wafer 432. In some cases, the aperture wafer 412 can be coupled to a first side of the meta-lens wafer 402. In some cases, the meta-lenses 406 on the meta-lens wafer 402 can be disposed on a second side of the meta-lens wafer 402 opposite the first side. In some cases, a distance between each aperture of the multiple apertures 416 and a corresponding meta-lens 406 of the meta-lenses 406 can be equal to a sum of a thickness of the aperture wafer 412 and a thickness of the meta-lens wafer 402. In some applications, a distance between the multiple apertures 416 and the meta-lenses 406 can affect optical performance, such as depth of field. In some cases, the aperture wafer 412 and/or the meta-lens wafer 402 can be polished to attain a desired thickness based on a desired distance between the apertures 416 and the meta-lenses 406.

In some cases, a first side of the spacer wafer 422 can be coupled to a second side of the meta-lens wafer 402 (e.g., the side having the meta-lenses 406 disposed thereon). In some examples, a second side of the spacer wafer 422 can be coupled to the optical sensor wafer 432. In some cases, the spacer structures 426 on the spacer wafer 422 can be designed to border the meta-lenses 406 on the first side of the spacer wafer 422. In some cases, the spacer structures 426 on the spacer wafer 422 can be designed to border the optical sensors 436. In some cases, the meta-lenses 406 and the optical sensors can be positioned within cavities 428 in the spacer structures. In some cases, a desired distance between the meta-lenses 406 and the optical sensors 436 can be equal to the back focal length (BFL) of the meta-lenses 406. In some cases, a thickness of the spacer structures 426 can be used to separate the meta-lenses 406 and the optical sensors 436 by the focal length of the meta-lenses 406. In some cases, the wafer stackups can create an array of meta-lenses 406, apertures 416, spacer structures 426, and optical sensors 436 having a common pitch. In some cases, by aligning the wafers 402, 412, 422, and 432, modules each comprising a meta-lens, an aperture, a spacer structure, and an optical sensor can be formed. In some cases, each aperture of the apertures 416 can be positioned over a corresponding meta-lens of the meta-lenses 406. In some cases, the meta-lens, aperture, and optical sensor for each meta-lens module can be aligned to an optical axis. For example, a meta-lens, an aperture, and a photosensitive region of an optical sensor can each be centered on the optical axis of the meta-lens 406. In some cases, the wafers 402, 412, 422, and 432 can be mechanically coupled using an epoxy. In some cases, an epoxy that is transparent to the relevant wavelengths of light can be selected. For example, a liquid optically clear adhesive (LOCA) can be used for visible light, NIR, and SWIR applications. In some cases, the epoxy can be disposed only in regions of the wafers 402, 412, 422, and 432 where light does not need to pass through.

FIG. 4F illustrates a cross-sectional view of a wafer stackup 450. As shown in the illustration, an aperture 462 of the multiple apertures 416 can be formed as an opening in the opaque layer 464 disposed on the aperture wafer 412. In some cases, during the wafer stacking process described with respect to FIG. 4E, the aperture wafer 412 can be coupled to the meta-lens wafer 402. In some cases, the combined thickness of the aperture wafer 412 and the meta-lens wafer 402 can create a spacing 660 between apertures 416 on the aperture wafer 412 and corresponding meta-lenses 406 on the meta-lens wafer 402. In some implementations, spacer structures 426 of the spacer wafer 422 can include cavities 428. In some cases, the meta-lenses 406 and the optical sensors 436 can be contained within the cavities 428. In some cases, a height of the spacer structures 426 can be configured to provide spacing 466 that places each optical sensor 436 at a focal plane of a corresponding meta-lens 406. In some cases, the optical sensors 436 can comprise a photosensitive region 438 and additional circuitry 440 as described above. In some cases, the photosensitive region 438 and the additional circuitry 440 can be fabricated on a surface of the optical sensor wafer 432.

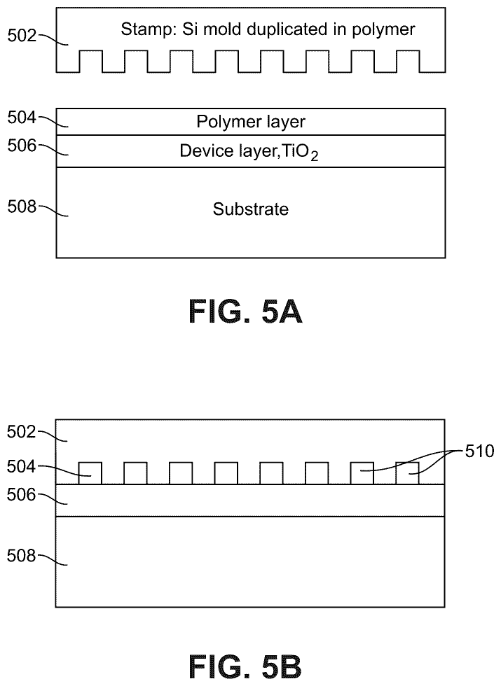

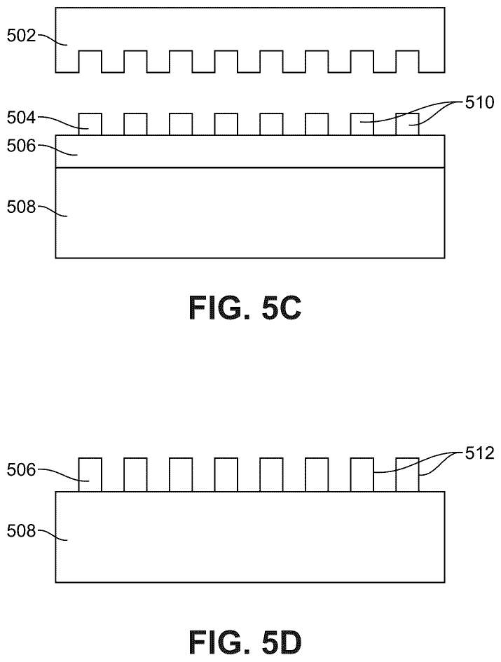

FIG. 5A through FIG. 5D illustrate an example nanoimprinting lithography process for manufacturing meta-lenses (e.g., a meta-lens wafer 402 shown in FIG. 4A). In the illustrated example, a mold can be formed from a meta-lens, such as a meta-lens manufactured using an e-beam lithography process on a silicon wafer as described above. In some cases, a mask or model can be formed using the meta-lens. In some cases, the mask of the meta-lens can be duplicated into an array of meta-lenses and formed into a stamp 502. In some cases, the stamp 502 can be used to transfer the pattern of the array of meta-lens to a device layer 506 disposed over a substrate 508. In some cases, the substrate 508 can be a material that is transparent to visible wavelength light, such as glass. In some cases, the device layer 506 can include a transparent material that can be used to form the pillars of meta-lenses on the substrate 508. In some cases, the device layer 506 can include a high refractive index material. For example, in some cases, the device layer 506 can include a material with a refractive index greater than 2. In some cases, the device layer 506 can include a material with a refractive index greater than 2.5. In some cases, the device layer 506 can include a material that is transparent to visible wavelength light. In one illustrative example, the device layer 506 can include Titanium Dioxide (TiO₂).

FIG. 5B illustrates an imprinting step of the process for manufacturing meta-lenses. In some cases, the stamp 502 can be pressed against the polymer layer 504 to create a negative pattern 510 of the stamp 502 impressed into the polymer layer. In some cases, the negative pattern 510 can also be referred to as a nanoimprint. FIG. 5C illustrates the negative pattern 510 disposed on top of the device layer 506 after removal of the stamp 502. In some cases, the polymer layer 504 can be heated until it becomes soft, which can allow the stamp 502 to deform the polymer layer 504. In some cases, after the heat is removed, the polymer can be cooled until hardened. In some cases, after the polymer 504 is cooled, stamp 502 can be removed, resulting in the negative pattern 510 imprinted into the polymer layer 504. In some cases, after removal of the stamp 502, the polymer layer 504 can be exposed to light and/or baked to cause the polymer material to harden and become resistant to etching. After removal of the stamp 502, the device layer 506 can be etched (e.g., via wet etching, dry etching, RIE or other etching techniques), and portions of the device layer 506 that are not covered and protected by the negative pattern 510 can be etched away and removed. After etching of the device layer is completed, the remaining polymer layer 504 can be removed. For example, the polymer layer 504 can be removed by organic stripping, inorganic stripping, dry stripping, or any other suitable technique.

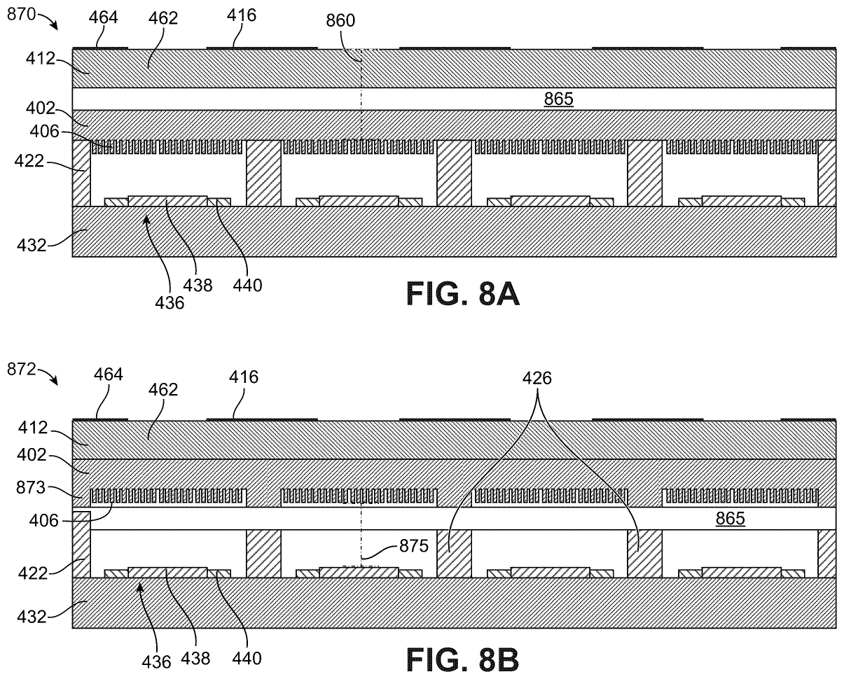

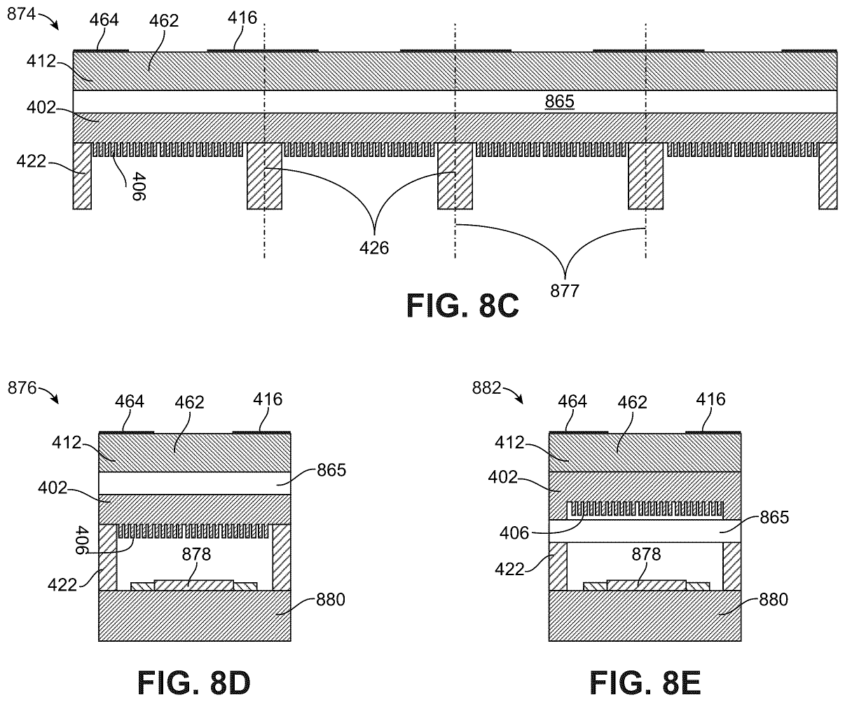

FIG. 5D illustrates a meta-lens pattern 512 etched into the device layer 506 after removal of the polymer layer 504. In some cases, a single meta-lens can be formed on the substrate 508. In some cases, an array of meta-lenses can be formed in the device layer 506. The example process illustrated by FIG. 5A through FIG. 5D can be referred to as a nanoimprint lithography process. The nanoimprint lithography process can be used as an alternative to fabricating meta-lenses using semiconductor fabrication techniques. In some cases, the meta-lenses fabricated using the nanoimprint lithography technique can be included in a wafer stackup similar to the wafer stackups illustrated in FIG. 4A through FIG. 4F and FIG. 8A through FIG. 8E.

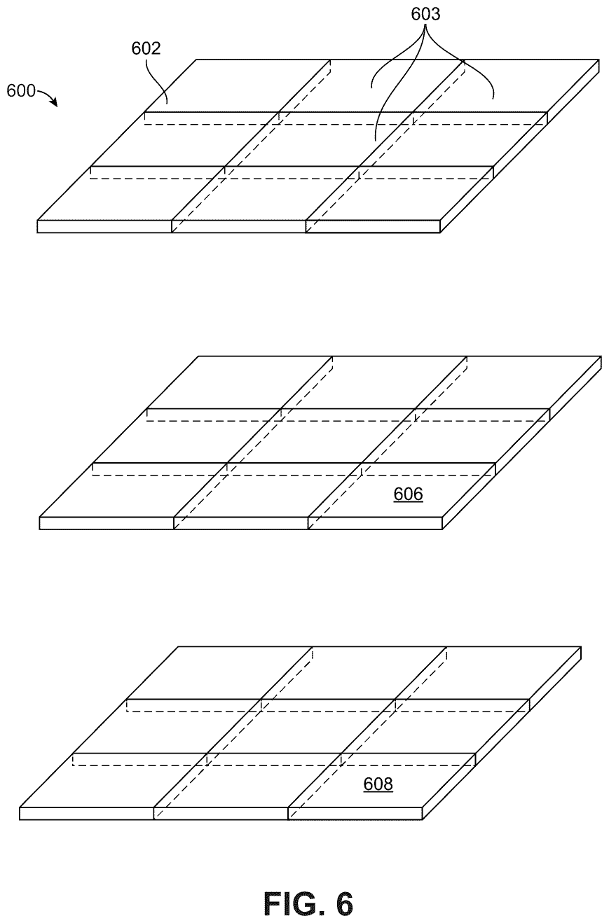

FIG. 6 illustrates another example wafer stackup 600 that can be used to fabricate optical systems that include meta-lenses (e.g., meta-lens camera modules). The stackup 600 can include a stacking of a BSI CMOS detector array and ROIC ASIC wafers. For instance, in some cases, a meta-lens wafer 602 (e.g., meta-lens wafer 402 shown in FIG. 4A and FIG. 4E above) can include an array of meta-lenses 603. The wafer stackup 600 can also include a detector component wafer 606 and a control and processing component wafer 608 (e.g., a ROIC+RICA ASIC die array). As discussed above, the meta-lens wafer 602, detector component wafer 606, and the control and processing component wafer 608 can be assembled in a wafer stacking technique. Although not shown in FIG. 6, the wafer stackup 600 can also include an aperture wafer (e.g., aperture wafer 412 shown in FIG. 4B) and/or an optical filter (e.g., optical filter 865 shown in FIG. 8A through FIG. 8E).

Meta-lenses structures can be patterned onto glass and silicon substrates. A stack of silicon substrates of BSI wafer and meta-lens substrate can provide the desired heights between lenses wafer surface and sensor focal plane array, which can allow tweaking of the optimal focal length to form sharp images. In some cases, an aperture array substrate can be added on top of the metal-lens array of the meta-lens wafer 602. In some cases, an optical filter substrate can be included in the stackup 600.

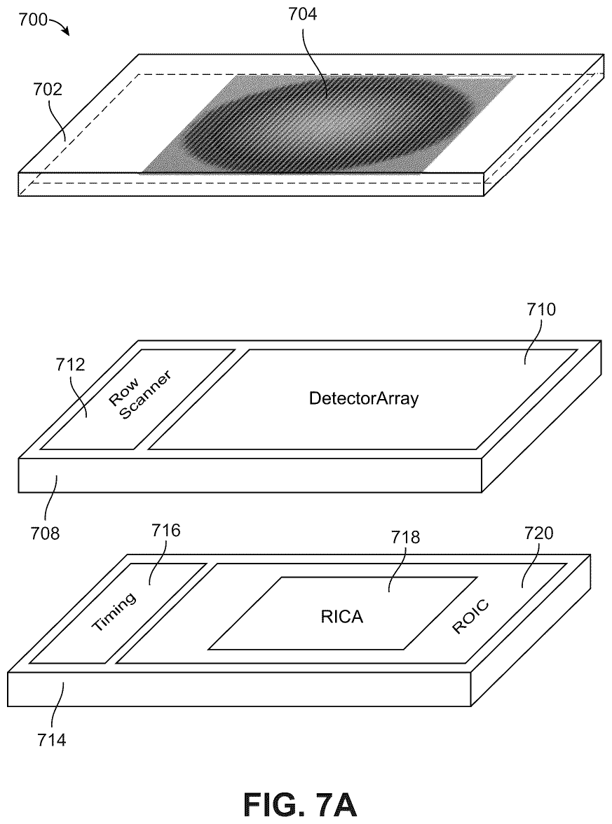

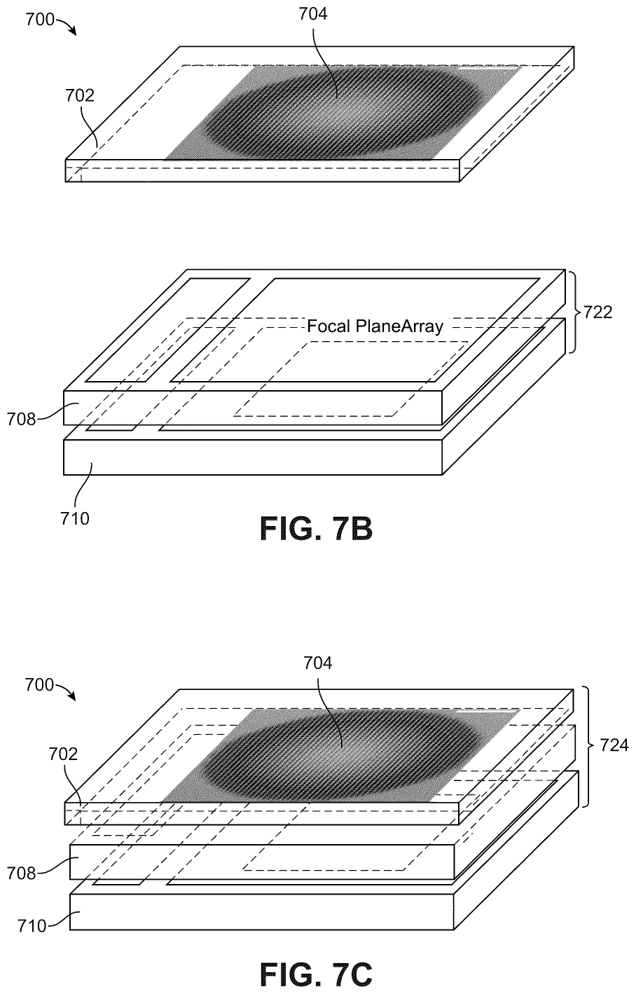

FIG. 7A through FIG. 7C illustrate perspective views of an example wafer stackup 700 that can be used to fabricate meta-lens camera modules. For example, the examples of FIG. 7A through FIG. 7C can be a fully integrated SWIR meta-lens array camera cube formed by stacking the BSI CMOS imager wafer. For example, FIG. 7A illustrates a stackup 700 that includes a meta-lens 704 disposed on a substrate 702, a detector component 708, and a control and processing component 714

In the illustrated example of FIG. 7A, the detector component 708 can include a detector array 710 and a row scanner 712. In some cases, the detector array 710 can include photosensitive elements that can detect light with a particular wavelength or range of wavelengths. For example, in some cases, the detector array can include photosensitive elements that can detect light in the SWIR wavelength. In one illustrative example, the photosensitive elements can detect light within a narrow band centered around approximately 1400 nm wavelength. In some aspects, the detector array 710 can include photosensitive elements that can detect visible light. In some cases, the row scanner 712 can be configured to scan the photosensitive elements in a scan pattern to read electrical signals (e.g., a voltage, current, or the like) that correspond to an amount of light detected by each photosensitive element during a particular time period (e.g., an exposure period).

In the illustrated example of FIG. 7A, the control and processing component 714 can include a timing control component 716, a reconfigurable instruction cell array (RICA) 718, and a readout integrated circuit (ROIC) 720. In some cases, the timing control component 716 can provide control signals to one or more components of the meta-lens stackup 700. For example, the timing control component can provide timing signals to control operations of the row scanner 712, the ROIC 720, and/or any other components included in the meta-lens stackup 700. In some aspects, the timing control component 716 can further provide timing signals to other components in a device that incorporates the meta-lens stackup 700.

In some cases, RICA 718 can be used to perform local image processing operations without requiring transferring image data over a bus to a processing unit. In some cases, the RICA can generate depth maps, stitch together multiple frames (or portions of frames) of image data, generate composite images from multiple captured images (or portions of images), as well as performing other image processing operations. As described above, in some cases, all of the components that form the stackup 700 can be fabricated using a semiconductor manufacturing process and assembled in a single wafer stacking process.

FIG. 7B and FIG. 7C illustrate example assembly steps that can be used to fabricate the meta-lens stackup 700. In the illustration of FIG. 7B, detector component 708 and the control and processing component 714 can be coupled together both mechanically and electrically to form a sensor chip 722. In some cases, electrical signals can be transmitted and received between the detector component 708 and the control and processing component 714 via the electrical connections. FIG. 7C illustrates the substrate 702 assembled together with the sensor chip 722 to form a meta-lens camera module 724. Although not shown, the meta-lens camera module 724 can also include an aperture, an optical filter and/or additional spacer structures as described herein. For example, supplemental spacer structures (not shown) can be disposed on the detector component 708 (or on a substrate that includes the detector component 708) to provide separation between an optical filter and the detector component.

FIG. 8A through FIG. 8E illustrate cross-sectional views of different example wafer stacking configurations. The illustrations of FIG. 8A through 8E include components labeled with reference numbers that are described above with respect to FIG. 4A through FIG. 4F and the components shown in FIG. 8A through 8E can be similar to and perform similar functions to identically numbered components in FIG. 4A through FIG. 4F. FIG. 8A illustrates a wafer stackup 870 that includes an optical filter 865. In some cases, the optical filter 865 can be a band-pass optical filter. In one illustrative example, the optical filter 865 can be configured to pass light at the SWIR wavelengths (e.g., in a narrow band around 1400 nm) while attenuating light at all other wavelengths. In the example of FIG. 8A, the optical filter 865 is disposed between the aperture wafer 412 and the meta-lens wafer 402. In such a configuration, a spacing 860 between the apertures 416 and the optical sensors 436 can be equal to the combined thickness of the aperture wafer 412, the optical filter 865, and the meta-lens wafer 402.

FIG. 8B illustrates an example wafer stackup 872 that includes the optical filter 865 disposed between the meta-lens wafer 402 and the spacer wafer 422. In some cases, placing the optical filter 865 after the meta-lens wafer 402 in the stackup 872 can cause the rays of light to be normally incident on the optical filter 865. Accordingly, in some cases, placing the optical filter 865 after the meta-lens wafer 402 in the stackup 872 can reduce blue-shift of the optical filter 865, and a narrower band optical filter 865 can be used. In some cases, the meta-lens wafer 402 can include an additional spacer structure 873 that can couple to the optical filter 865 to provide spacing between the pillars (e.g., pillars 118 shown in FIG. 1A above) of the meta-lenses 406 and the optical filter 865. In some cases, the additional spacer structures 873 can be fabricated on the meta-lens wafer as part of the same manufacturing process used to fabricate the meta-lenses 406 on the meta-lens wafer. In some cases, the distance 875 between the meta-lenses 406 and the optical sensors 436 can be a sum of the height of the additional spacer structures 873, the optical filter 865, and the spacer structures 426 of the spacer wafer 422. In the example configuration of FIG. 8B, the distance 875 between the meta-lenses 406 and corresponding optical sensors 436 can be configured to be equal to the back focal length of the meta-lenses 406.

FIG. 8C illustrates an example wafer stackup 874. The wafer stackup 874 can include an aperture wafer 412, an optical filter 865, a meta-lens wafer 402, and a spacer wafer 422 in a similar configuration to the wafer stackup 870 shown in FIG. 8A. In the example wafer stackup 874, the optical sensor wafer 432 can be omitted from the stackup 870. In some cases, the wafer stackup 874 can be used to fabricate meta-lens modules that can later be coupled individually to optical sensors. For example, individual meta-lens modules can be formed by dicing the wafer stackup 874 along dice lines 877.

FIG. 8D illustrates an example of a meta-lens camera module 876. As used herein, a meta-lens camera module can include any optical system that incorporates a meta-lens as a component. In some cases, the meta-lens camera module 876 can be formed by dicing the wafer stackup 870 shown in FIG. 8A. In some cases, the meta-lens camera module 876 can be formed by coupling the meta-lens modules described with respect to FIG. 8C with an optical detector 878 on a substrate 880.

FIG. 8E illustrates another example of a meta-lens camera module 882. In some cases, the meta-lens module 882 can be formed by dicing the wafer stackup 872 shown in FIG. 8B. In some examples, the meta-lens camera module 882 can be formed from a meta-lens module diced from a wafer stackup similar to the wafer stackup 872 that omits the optical sensor wafer 432. In such examples, the meta-lens camera module 882 can be formed by coupling the meta-lens module with an optical detector 878 on a substrate 880.

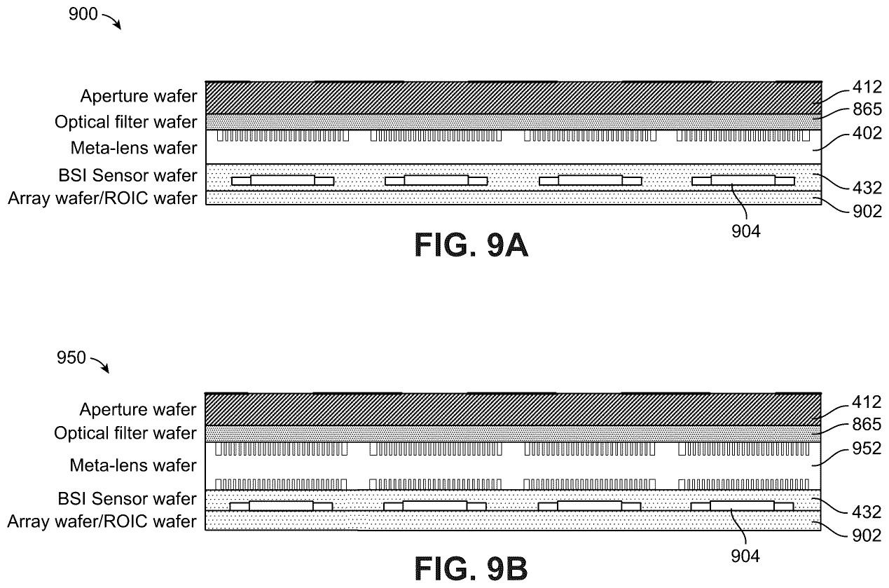

FIG. 9A and FIG. 9B are diagrams illustrating cross-sections of example meta-lens arrays on stacking imager wafers. The stacking configurations of FIG. 9A and FIG. 9B may include an example of a SWIR meta-lenses array on a stacking CMOS imager wafer. The stacking configurations can include a fully integrated BSI wafer stacked without an airgap spacer wafer being needed. As described previously, FIG. 8A illustrates a cross-sectional views of a wafer stacking configuration that includes an airgap spacer wafer (e.g., a single-sided meta-lens structure wafer integrated onto an SWIR FSI detector array wafer bonded with a silicon ROIC wafer and an airgap spacer wafer). FIG. 9A and FIG. 9B illustrate stacking configurations that do not include spacer wafers. For instance, FIG. 9A is a stacking configuration 900 that includes an aperture wafer 412, stacked on an optical filter wafer 865, stacked on a meta-lens wafer 402, stacked on a BSI optical sensor (or detector) wafer 432, stacked on an array wafer and/or an ROIC wafer 902. In one illustrative example, the stacking configuration 900 of FIG. 9A can include a single-sided meta-lens structure wafer stacked on SWIR BSI optical sensor wafer 432 and silicon ROIC ASIC wafers 902 without a spacer wafer. FIG. 9B is a stacking configuration 952 that includes an aperture wafer 412, stacked on an optical filter wafer 865, stacked on a double-sided meta-lens wafer 952, stacked on a BSI optical sensor (or detector) wafer 432, stacked on an array wafer and/or an ROIC wafer 902. In one illustrative example, the stacking configuration of FIG. 9B can include a double-sided meta-lens structure wafer 952 stacked on SWIR BSI optical sensor array 432 and silicon ROIC ASIC wafers 902 without a spacer wafer. In some cases, the double-sided meta-lens wafer 952 may be formed, for example, by using a process used to form a single-sided meta-lens wafer (such as meta-lens wafer 402) on both sides of the double-sided meta-lens wafer 952.

As discussed above, the air gap provided by the silicon spacers may be replaced by a solid wafer of glass and/or silicon. In some cases, rather than including a separate flat spacer that is stacked on the optical sensor wafer 432, the spacer may be directly integrated with the sensor wafer 432. For example, as compared to optical sensor 436 of FIGS. 4F, 8A, 8B, optical detector 878 of FIGS. 8D and 8E, where the optical sensor/detector 436/878 is exposed on a top surface (e.g., a surface of the optical sensor 904 that faces towards the lens/meta-lens) of the optical sensor wafer 432, optical sensor 904 may be encapsulated/embedded in the optical sensor wafer 432 such that the optical sensor 904 is directly covered (e.g., without an air gap) by a solid covering. In some cases, a bottom surface of the optical sensor 904 (e.g., a surface of the optical sensor 904 that faces away from the lens/meta-lens) may not be level with a bottom surface of the optical sensor wafer 432 (e.g., a surface of the optical sensor wafer 432 that faces away from the lens/meta-lens), as shown in stacking configuration 900 of FIG. 9A. In other cases, the bottom surface of the optical sensor 904 may be exposed at the bottom of the optical sensor wafer 432, as shown in stacking configuration 950 of FIG. 9B.

In some cases, the optical sensor 904 may be encapsulated/embedded in the optical sensor wafer 432 by reducing an amount of grinding of the optical sensor wafer 432 during fabrication. For example, when producing an optical sensor for a visible light, the optical sensor may be etched/deposited/stacked/etc. in the optical sensor wafter 432 below a top surface of the optical sensor wafer 432. During production, the optical sensor wafer 432 may be ground down to expose the top surface of the optical sensor as silicon (e.g., of the optical sensor wafer 432) may absorb light at visible light wavelengths. However, as silicon is transparent at SWIR wavelengths, the top surface of the optical sensor 904 may be directly covered (e.g., covered by without an air gap) a layer of silicon. This covering layer of silicon (or glass) may be a solid spacer covering (e.g., over) the optical sensor 904.

In some cases, a portion of the optical sensor wafer 432 may act as the solid spacer covering. For example, rather than grinding the optical sensor wafer 432 until the optical sensor 904 is exposed, the optical sensor wafer 432 may be polished/ground so that an appropriate amount of silicon may be left over the optical sensor 904 to act as the spacer. In some examples, the optical sensor wafer 432 may be pre-ground/polished flat and the optical sensor may be manufactured at an appropriate position within the optical sensor wafer 432 so that there may be an appropriate amount of silicon left over the optical sensor 904 to act as the solid spacer.

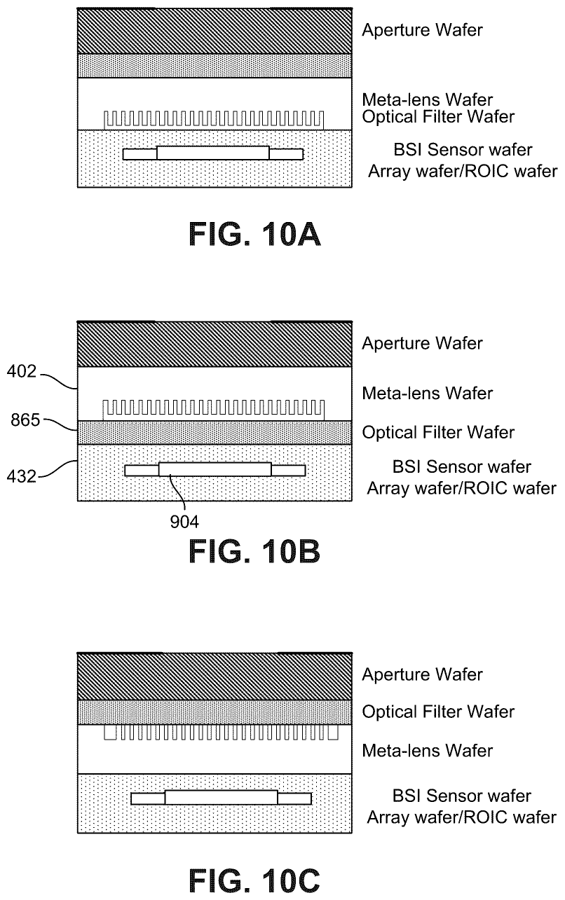

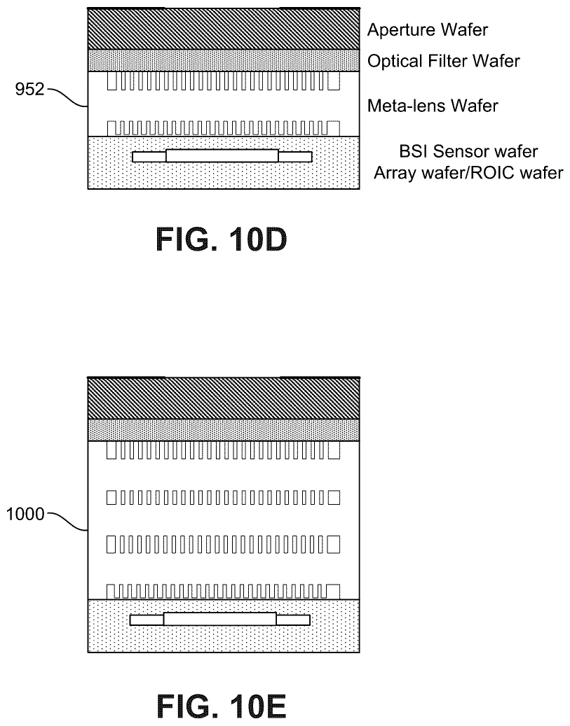

FIG. 10A through FIG. 10E are diagrams illustrating cross-sections of example meta-lens camera cube configurations, including single-sided and double-sided meta-lens configurations. For example, FIG. 10A and FIG. 10B illustrate a meta-lens camera cube configuration with shorter meta-lens focal lengths, for example where the meta-lens wafer 432 is positioned relatively close to the optical sensor 904 as compared to FIG. 10C where the meta-lens wafer 402 is positioned relatively further from the optical sensor 904. Additionally, FIG. 10B illustrates a configuration where the optical filter 865 is disposed between the meta-lens wafer 402 and the optical sensor wafer 432 (e.g., solid covering over the optical sensor 904). FIG. 10C illustrates a meta-lens camera cube configuration with a longer meta-lens focal length (as compared to those of FIG. 10A and FIG. 10B). FIG. 10D illustrates a meta-lens camera cube configuration with a relatively short focal length and a double-sided meta-lens 952. FIG. 10E illustrates a meta-lens camera cube configuration with multiple stacked meta-lenses 1002 and a relatively short focal length.

The systems and techniques can build upon such a wafer level fabrication of meta-lenses to realize more complex optical systems in an even more compact and more cost-effective way. For instance, the air gap can be replaced by the silicon (e.g., of the optical sensor wafer) of a sensor (e.g., a back side illuminated sensor (BSI)), or in some cases a simple bulk silicon wafer. For example, a bulk silicon wafer (or glass wafer) of an appropriate thickness may be stacked over (e.g., flush with) the optical sensor 904 (e.g., the optical sensor may be covered over by a solid spacer) with an exposed top surface. In such cases, the optical sensor wafer 432 may be ground such that the optical sensor 904 is exposed of the top surface of the optical sensor wafer 432, and the bulk silicon wafer (or glass wafer) directly stacked on top of the optical sensor wafer 432 and optical sensor 904.

Removing the air gap (and in some cases replacing the air gap by silicon spacers), as shown in the examples of FIG. 9A-FIG. 10E, can have advantages over other types of meta-lens configurations. For instance, because silicon is transparent at SWIR wavelengths (e.g., more than 1300 nm), including silicon spacers would not impact any optical properties of the sensor. Such a solution would allow a fabrication to perform a simple task of stacking two or more flat surfaces. Also, because silicon has a high refractive index (e.g., approximately 3.4), the thickness of the spacer can be reduced by the refractive index amount (e.g., 3.4) with respect to an air gap spacer (e.g., 1 millimeter (mm) instead of a 3.4 mm distance between the lens and the active sensor area), allowing fabrication of a more compact sensor. Furthermore, it can be easier to stack flat surfaces on top of flat surfaces, and does not require as much alignment nor the design and fabrication of a specific air gap spacer wafer, potentially reducing the complexity and cost of a meta-lens sensor.

As shown in the various examples of FIG. 9A-FIG. 10E, several meta-lenses can be stacked and alternated on top on flat silicon spacers as needed to design more complex optical systems. Some lens systems comprise multiple lenses (e.g., 5-10 lenses), and the configurations of FIG. 9A-FIG. 10E can allow the optical performances of a meta-lens sensor to be significantly increased when needed. Moreover, the systems and techniques provide versatility, in that the order of elements can be changed if appropriate, such as putting an optical filter before or after.

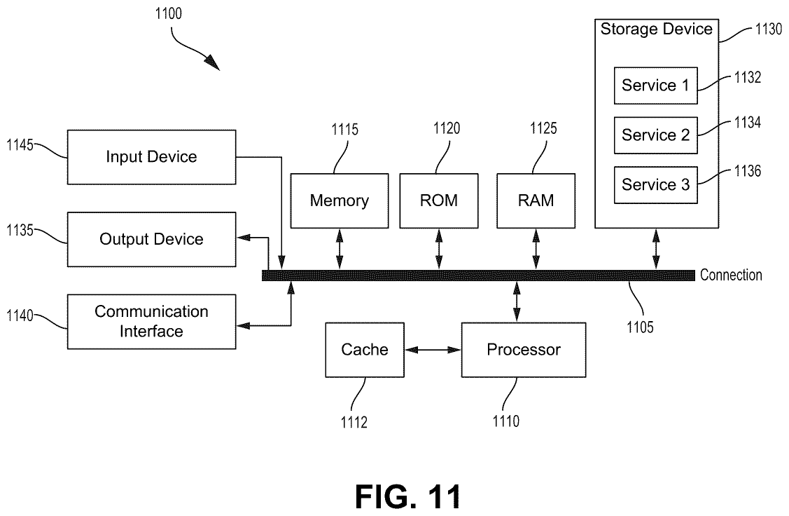

FIG. 11 is a diagram illustrating an example of a system for implementing certain aspects of the present technology. In particular, FIG. 11 illustrates an example of computing system 1100, which can be for example any computing device making up internal computing system, a remote computing system, a camera, or any component thereof in which the components of the system are in communication with each other using connection 1105. Connection 1105 can be a physical connection using a bus, or a direct connection into processor 1110, such as in a chipset architecture. Connection 1105 can also be a virtual connection, networked connection, or logical connection.

In some embodiments, computing system 1100 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 1100 includes at least one processing unit (CPU or processor) 1110 and connection 1105 that couples various system components including system memory 1115, such as read-only memory (ROM) 1120 and random access memory (RAM) 1125 to processor 1110. Computing system 1100 can include a cache 1112 of high-speed memory connected directly with, in close proximity to, or integrated as part of processor 1110.

Processor 1110 can include any general purpose processor and a hardware service or software service, such as services 1132, 1134, and 1136 stored in storage device 1130, configured to control processor 1110 as well as a special-purpose processor where software instructions are incorporated into the actual processor design. Processor 1110 may essentially be a completely self-contained computing system, containing multiple cores or processors, a bus, memory controller, cache, etc. A multi-core processor may be symmetric or asymmetric.

To enable user interaction, computing system 1100 includes an input device 1145, which can represent any number of input mechanisms, such as a microphone for speech, a touch-sensitive screen for gesture or graphical input, keyboard, mouse, motion input, speech, a camera for visual input, etc. Computing system 1100 can also include output device 1135, which can be one or more of a number of output mechanisms. In some instances, multimodal systems can enable a user to provide multiple types of input/output to communicate with computing system 1100. Computing system 1100 can include communications interface 1140, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1140 may also include one or more Global Navigation Satellite System (GNSS) receivers or transceivers that are used to determine a location of the computing system 1100 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1130 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 1130 can include software services, servers, services, etc., that when the code that defines such software is executed by the processor 1110, it causes the system to perform a function. In some embodiments, a hardware service that performs a particular function can include the software component stored in a computer-readable medium in connection with the necessary hardware components, such as processor 1110, connection 1105, output device 1135, etc., to carry out the function.

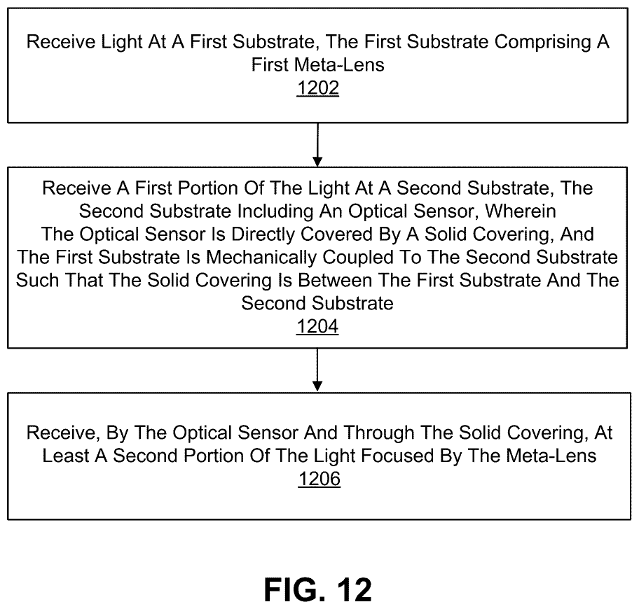

FIG. 12 is a flow diagram illustrating an imaging process using a meta-lens 1200, in accordance with aspects of the present disclosure. The process 700 may be performed by a computing device (or apparatus) or a component (e.g., a chipset, codec, lens, substrate layer, etc.) of the computing device, such as the meta-lens assemblies shown in FIGS. 9A, 9B, and 10A-10E, processor 1110 of FIG. 11, input device 1145 of FIG. 11, etc. The computing device may be a mobile device (e.g., a mobile phone), a network-connected wearable such as a watch, an extended reality (XR) device such as a virtual reality (VR) device or augmented reality (AR) device, a vehicle or component or system of a vehicle, or other type of computing device.

At block 1202, the computing device (or component thereof) may receive light at a first substrate (e.g., meta-lens wafer 402 of FIGS. 4A, 4E, 4F, 9A-9B, and 10A-10E, meta lens wafer 952 of FIGS. 9B and 10D, etc.) the first substrate comprising a first meta-lens (e.g., meta-lens 100 of FIG. 1A, meta-lens 200 of FIG. 2, meta-lens 310 of FIG. 3, meta-lenses 406 of FIG. 4A, etc.). In some cases, the first substrate further comprises a second meta-lens (e.g., in FIG. 9B, FIG. 10D, and FIG. 10E).

At block 1204, the computing device (or component thereof) may receive a first portion of the light at a second substrate (e.g., optical sensor wafer 432 of FIGS. 4D, 9A-9B, 10A-10F, etc.), the second substrate including an optical sensor, wherein: the optical sensor is directly covered by a solid covering, and the first substrate is mechanically coupled to the second substrate such that the solid covering is between the first substrate and the second substrate. In some cases, the solid covering comprises a portion of the second substrate. In some examples, the second substrate comprises a silicon substrate. In some cases, the solid covering comprises silicon substrate. In some examples, the solid covering comprises glass. In some cases, the solid covering comprises a third substrate disposed on the second substrate and wherein the third substrate is mechanically coupled to the second substrate. In some examples, an optical filter (e.g., optical filter 865 of FIGS. 9A-9B, 10B, etc.) is disposed between the first substrate and the second substrate. In some cases, the optical filter is between the solid covering and the first substrate. In some examples, the optical sensor comprises a back side illuminated optical sensor. In some cases, the optical sensor is flush with the solid covering.

At block 1206, the computing device (or component thereof) may receive, by the optical sensor (e.g., optical sensor 904 of FIGS. 9A-9B, 10B, etc.) and through the solid covering, at least a second portion of the light focused by the first meta-lens. In some cases, the computing device (or component thereof) may generate, using at least the second portion of the light focused by the first meta-lens, an image, and output the image.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the embodiments and examples provided herein. However, it will be understood by one of ordinary skill in the art that the embodiments may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

One of ordinary skill will appreciate that the less than (“<”) and greater than (“>”) symbols or terminology used herein can be replaced with less than or equal to (“ ”) and greater than or equal to (“ ”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:
Aspect 1. An apparatus comprising: a first substrate comprising a first meta-lens; a second substrate, the second substrate including an optical sensor, wherein: the optical sensor is directly covered by a solid covering, and the first substrate is mechanically coupled to the second substrate such that the solid covering is between the first substrate and the second substrate.
Aspect 2. The apparatus of Aspect 1, wherein the solid covering comprises a portion of the second substrate.
Aspect 3. The apparatus of Aspect 2, wherein the second substrate comprises a silicon substrate.
Aspect 4. The apparatus of any of Aspects 1-3, wherein the solid covering comprises silicon substrate.
Aspect 5. The apparatus of any of Aspects 1-4, wherein the solid covering comprises glass.
Aspect 6. The apparatus of any of Aspects 1-5, wherein the solid covering comprises a third substrate disposed on the second substrate and wherein the third substrate is mechanically coupled to the second substrate.
Aspect 7. The apparatus of any of Aspects 1-6, further comprising an optical filter disposed between the first substrate and the second substrate.
Aspect 8. The apparatus of Aspect 7, wherein the optical filter is between the solid covering and the first substrate.
Aspect 9. The apparatus of any of Aspects 1-8, wherein the optical sensor comprises a back side illuminated optical sensor.
Aspect 10. The apparatus of any of Aspects 1-9, wherein the optical sensor is flush with the solid covering.
Aspect 11. The apparatus of any of Aspects 1-10, wherein the first substrate further comprises a second meta-lens.
Aspect 12. A method for imaging comprising: receiving light at a first substrate, the first substrate comprising a first meta-lens; receiving a first portion of the light at a second substrate, the second substrate including an optical sensor, wherein: the optical sensor is directly covered by a solid covering, and the first substrate is mechanically coupled to the second substrate such that the solid covering is between the first substrate and the second substrate; and receiving, by the optical sensor and through the solid covering, at least a second portion of the light focused by the first meta-lens.
Aspect 13. The method of Aspect 12, wherein the solid covering comprises a portion of the second substrate.
Aspect 14. The method of Aspect 13, wherein the second substrate comprises a silicon substrate.
Aspect 15. The method of any of Aspects 12-14, wherein the solid covering comprises silicon substrate.
Aspect 16. The method of any of Aspects 12-15, wherein the solid covering comprises glass.
Aspect 17. The method of any of Aspects 12-16, wherein the solid covering comprises a third substrate disposed on the second substrate and wherein the third substrate is mechanically coupled to the second substrate.
Aspect 18. The method of any of Aspects 12-17, where in an optical filter is disposed between the first substrate and the second substrate.
Aspect 19. The method of Aspect 18, wherein the optical filter is between the solid covering and the first substrate.
Aspect 20. The method of any of Aspects 12-19, wherein the optical sensor comprises a back side illuminated optical sensor.
Aspect 21. The method of any of Aspects 12-20, wherein the optical sensor is flush with the solid covering.
Aspect 22. The method of any of Aspects 12-21, wherein the first substrate further comprises a second meta-lens.
Aspect 23. The method of any of Aspects 12-22, further comprising: generating, using at least the second portion of the light focused by the first meta-lens, an image; and outputting the image.
Aspect 24: An apparatus for imaging comprising: means for receiving light at a first substrate, the first substrate comprising a first meta-lens; means for receiving a first portion of the light at a second substrate, the second substrate including an optical sensor, wherein: the optical sensor is directly covered by a solid covering, and the first substrate is mechanically coupled to the second substrate such that the solid covering is between the first substrate and the second substrate; and means for receiving, by the optical sensor and through the solid covering, at least a second portion of the light focused by the first meta-lens.
Aspect 25. The apparatus of Aspect 24, wherein the solid covering comprises a portion of the second substrate.
Aspect 26. The apparatus of Aspect 25, wherein the second substrate comprises a silicon substrate.
Aspect 27. The apparatus of any of Aspects 24-26, wherein the solid covering comprises silicon substrate.
Aspect 28. The apparatus of any of Aspects 24-27, wherein the solid covering comprises glass.
Aspect 29. The apparatus of any of Aspects 24-28, wherein the solid covering comprises a third substrate disposed on the second substrate and wherein the third substrate is mechanically coupled to the second substrate.
Aspect 30. The apparatus of any of Aspects 24-27, wherein in an optical filter is disposed between the first substrate and the second substrate.
Aspect 31. A non-transitory computer-readable medium having stored thereon instructions that, when executed by at least one processor, cause the at least one processor to perform operations according to any of Aspects 12 to 23.
Aspect 32: An apparatus comprising means for performing any of the operations according to any of Aspects 12 to 23.

What is claimed is:

1. An apparatus comprising:
a first substrate comprising a first meta-lens; and
a second substrate, the second substrate including an optical sensor, wherein:
the optical sensor is directly covered by a solid covering, and
the first substrate is mechanically coupled to the second substrate such that the solid covering is between the first substrate and the second substrate.

2. The apparatus of claim 1, wherein the solid covering comprises a portion of the second substrate, and wherein the solid covering comprises a solid spacer.

3. The apparatus of claim 2, wherein the second substrate comprises a silicon substrate.

4. The apparatus of claim 1, wherein the solid covering comprises silicon substrate.

5. The apparatus of claim 1, wherein the solid covering comprises glass.

6. The apparatus of claim 1, wherein the solid covering comprises a third substrate disposed on the second substrate and wherein the third substrate is mechanically coupled to the second substrate.

7. The apparatus of claim 1, further comprising an optical filter disposed between the first substrate and the second substrate.

8. The apparatus of claim 7, wherein the optical filter is between the solid covering and the first substrate.

9. The apparatus of claim 1, wherein the optical sensor comprises a back side illuminated optical sensor.

10. The apparatus of claim 1, wherein the optical sensor is flush with the solid covering.

11. The apparatus of claim 1, wherein the first substrate further comprises a second meta-lens.

12. A method for imaging comprising:
receiving light at a first substrate, the first substrate comprising a first meta-lens;
receiving a first portion of the light at a second substrate, the second substrate including an optical sensor, wherein:
the optical sensor is directly covered by a solid covering, and
the first substrate is mechanically coupled to the second substrate such that the solid covering is between the first substrate and the second substrate; and
receiving, by the optical sensor and through the solid covering, at least a second portion of the light focused by the first meta-lens.

13. The method of claim 12, wherein the solid covering comprises a portion of the second substrate.

14. The method of claim 13, wherein the second substrate comprises a silicon substrate.

15. The method of claim 12, wherein the solid covering comprises silicon substrate.

16. The method of claim 12, wherein the solid covering comprises glass.

17. The method of claim 12, wherein the solid covering comprises a third substrate disposed on the second substrate and wherein the third substrate is mechanically coupled to the second substrate.

18. The method of claim 12, where in an optical filter is disposed between the first substrate and the second substrate.

19. The method of claim 18, wherein the optical filter is between the solid covering and the first substrate.

20. The method of claim 12, wherein the optical sensor comprises a back side illuminated optical sensor.

21. The method of claim 12, wherein the optical sensor is flush with the solid covering.

22. The method of claim 12, wherein the first substrate further comprises a second meta-lens.

23. The method of claim 12, further comprising:
generating, using at least the second portion of the light focused by the first meta-lens, an image; and
outputting the image.

24. An apparatus for imaging comprising:
means for receiving light at a first substrate, the first substrate comprising a first meta-lens;
means for receiving a first portion of the light at a second substrate, the second substrate including an optical sensor, wherein:
the optical sensor is directly covered by a solid covering, and
the first substrate is mechanically coupled to the second substrate such that the solid covering is between the first substrate and the second substrate; and
means for receiving, by the optical sensor and through the solid covering, at least a second portion of the light focused by the first meta-lens.

25. The apparatus of claim 24, wherein the solid covering comprises a portion of the second substrate.

26. The apparatus of claim 25, wherein the second substrate comprises a silicon substrate.

27. The apparatus of claim 24, wherein the solid covering comprises silicon substrate.

28. The apparatus of claim 24, wherein the solid covering comprises glass.

29. The apparatus of claim 24, wherein the solid covering comprises a third substrate disposed on the second substrate and wherein the third substrate is mechanically coupled to the second substrate.

30. The apparatus of claim 24 wherein an optical filter is disposed between the first substrate and the second substrate.
